(19) United States
(12) Patent Application Publication
(10) Pub. No.: US 2025/0028811 A1
(43) Pub. Date: Jan. 23, 2025

(54) INFORMATION PROCESSING SYSTEM AND NON-TRANSITORY COMPUTER READABLE MEDIUM

(71) Applicant: Fujifilm Business Innovation Corp., Tokyo (JP)

(72) Inventor: Koji HAYASHI, Kanagawa (JP)

(73) Assignee: Fujifilm Business Innovation Corp., Tokyo (JP)

(21) Appl. No.: 18/593,343

(22) Filed: Mar. 1, 2024

(30) Foreign Application Priority Data
Jul. 21, 2023 (JP) 2023-119424

(51) Int. Cl. G06F 21/44; G06F 21/62

(52) U.S. Cl. CPC G06F 21/44; G06F 21/62

(57) ABSTRACT

An information processing system includes a processor configured to recognize a new device administrator as a device administrator in a case where first authentication information and second authentication information for the device administrator are received, reset or overwrite the second authentication information in a case where an instruction to reset or overwrite the second authentication information is given by a user belonging to a predetermined authority group permitted to reset or overwrite the second authentication information for the device administrator, and perform processing of initializing the first authentication information for the device administrator in a case where the second authentication information is reset or overwritten.

### CROSS-REFERENCE TO RELATED APPLICATIONS

This application is based on and claims priority under 35 USC 119 from Japanese Patent Application No. 2023-119424 filed Jul. 21, 2023.

### BACKGROUND

### (i) Technical Field

The present disclosure relates to an information processing system and a non-transitory computer readable medium.

### (ii) Related Art

Japanese Unexamined Patent Application Publication No. 2006-202180 discloses a service providing system in which a group user management system including a management module is provided separately from an application for providing a service. In the management module, a user management unit that manages user information, a group management unit that manages a group to which a user belongs, and an access authority list processing unit that manages a function capable of setting an access authority in the application are provided. Then, Japanese Unexamined Patent Application Publication No. 2006-202180 discloses that an operation operator manages the access of the user to the application based on the group to which the user belongs by causing the user to belong to one or more groups and setting the access authority to the application for each group.

### SUMMARY

In an operation form in which multi-factor authentication is used for authentication of a device administrator, it is necessary to update multi-factor information at the time of person-in-charge handover of the device administrator. However, in a case where the device administrator is suddenly absent in a situation where the handover of the person in charge has not been performed, no one can manage the device as the device administrator. Even though first authentication information that is one of the factors of the multi-factor authentication of the device administrator is shared, since there is no alternative to second authentication information such as biological information, a new device administrator is not recognized as the device administrator.

In recent years, from the viewpoint of security enhancement, an operation in which an authority of user management is not given to a maintenance inspector is general. It is necessary for the maintenance inspector to initialize user information in order to restore the original state, and the original state cannot be restored to unless the device itself is initialized.

Aspects of non-limiting embodiments of the present disclosure relate to an information processing system and a non-transitory computer readable medium that enable handover of a device administrator even though the device administrator is suddenly absent in a situation in which handover of a person in charge has not been performed in an operation form in which multi-factor authentication is used for authentication of the device administrator.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including a processor configured to recognize a new device administrator as a device administrator in a case where first authentication information and second authentication information for the device administrator are received, reset or overwrite the second authentication information in a case where an instruction to reset or overwrite the second authentication information is given by a user belonging to a predetermined authority group permitted to reset or overwrite the second authentication information for the device administrator, and perform processing of initializing the first authentication information for the device administrator in a case where the second authentication information is reset or overwritten.

### BRIEF DESCRIPTION OF THE DRAWINGS

An exemplary embodiment of the present disclosure will be described in detail based on the following figures, wherein:

FIG. 1 is a perspective view illustrating an appearance of an image forming apparatus according to the present exemplary embodiment;

FIG. 2 is a block diagram illustrating a configuration of major parts of an electrical system of the image forming apparatus according to the present exemplary embodiment;

FIG. 3 is a functional block diagram illustrating an example of a functional configuration of a controller of the image forming apparatus according to the present exemplary embodiment;

FIG. 4 is a flowchart illustrating an example of a flow of processing performed in the controller of the image forming apparatus according to the present exemplary embodiment when a user belonging to an authority group resets or overwrites multi-factor information of a device administrator;

FIG. 5 is a flowchart illustrating an example of a flow of processing performed in the controller of the image forming apparatus according to the present exemplary embodiment after an access to a “setting of multi-factor information of device administrator” screen is enabled;

FIG. 6 is a flowchart illustrating an example of a flow of processing performed in the controller of the image forming apparatus according to the present exemplary embodiment when an ID and a password are newly set after an ID and a password of the device administrator are initialized;

FIG. 7 is a flowchart illustrating an example of a flow of processing performed in the controller of the image forming apparatus according to the present exemplary embodiment when function setting of the device administrator is performed after the new ID and password for the device administrator is set;

FIG. 8 is a diagram illustrating an example of an initial state of IDs, passwords, pieces of multi-factor information, and an authority group of users under the management of the device administrator;

FIG. 9 is a diagram illustrating occurrence of an absence state of the device administrator;

FIG. 10 is a diagram illustrating an example in which a general user A belonging to the authority group overwrites multi-factor information of the device administrator with multi-factor information of the general user A;

FIG. 11 is a diagram for describing a behavior of the controller (resetting of the ID and password of the device administrator) when the general user A executes an authority to reset or overwrite the multi-factor information of the device administrator;

FIG. 12 is a diagram for describing a behavior of the controller (informing the authority group of the resetting or overwriting of the multi-factor information of the device administrator) when the general user A executes the authority to reset or overwrite the multi-factor information of the device administrator;

FIG. 13 is a diagram for describing a behavior of the controller (informing the authority group of the change of the authority) when the general user A resets or overwrites the multi-factor information of the device administrator;

FIG. 14 is a diagram illustrating an example in which the ID and the password of the device administrator are changed and the general user A logs in as a new device administrator;

FIG. 15 is a diagram illustrating an example in which an account of the general user A is locked out;

FIG. 16 is a diagram for describing a case where general users B to D are given an authority of the authority group and are informed that the authority is changed; and

FIG. 17 is a diagram for describing an example of handover of the device administrator to the general user B from the general user A in a state where the device administrator is present.

### DETAILED DESCRIPTION

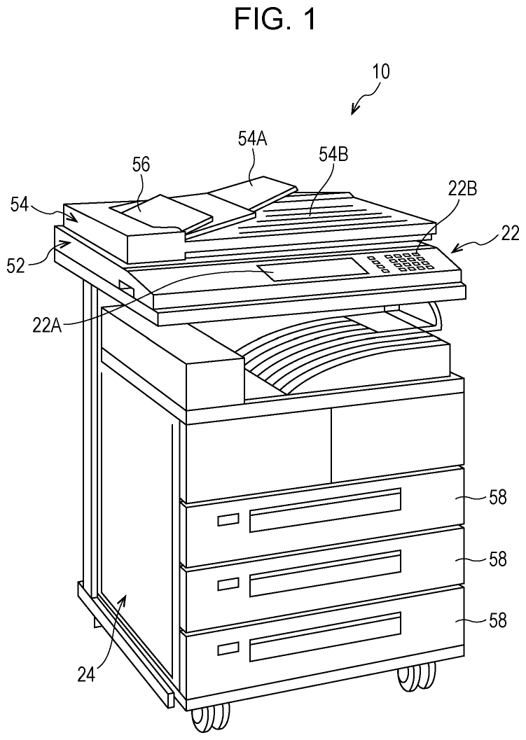

Hereinafter, an example of an exemplary embodiment of the present disclosure will be described in detail with reference to the drawings. Note that, in the present exemplary embodiment, an image forming apparatus will be described as an example of an information processing system. FIG. 1 is a perspective view illustrating an appearance of an image forming apparatus 10 according to the present exemplary embodiment.

The image forming apparatus 10 according to the present exemplary embodiment has a print function of receiving various kinds of data via a communication line such as a network and performing image forming processing based on the received data. In addition, the image forming apparatus 10 according to the present exemplary embodiment has a plurality of functions such as a reading function of reading a document to obtain image information representing the document, a copying function of copying an image recorded on the document onto a sheet, a facsimile function of transmitting and receiving various kinds of data via a telephone line (not illustrated), a transfer function of transferring document information such as image information or the like read by the reading function or the like, and a storage function of storing document information such as the read image information.

In addition, the image forming apparatus 10 according to the present exemplary embodiment includes a document reading unit 52 at an upper portion of the apparatus, and an image forming unit 24 is disposed below the document reading unit 52. The document reading unit 52 includes a document conveyance unit (not illustrated) in a document covering part 54. The document conveyance unit sequentially draws in documents 56 placed on a document feed unit 54A provided in the document covering part 54, conveys the documents 56 onto platen glass (not illustrated), and reads images recorded on the documents 56. In addition, the document conveyance unit also ejects the documents 56 whose image has been read, onto a document ejection unit 54B provided in the document covering part 54.

In addition, a user interface 22 for receiving various instruction operations by users is provided in the document reading unit 52. A display 22A on which display buttons that implement reception of instruction operations by a software program and various kinds of information are displayed, hardware keys 22B such as a numeric keypad, and the like are provided in the user interface 22. A touch panel type in which a display device such as a liquid crystal panel and a position input device such as a touch pad are combined is employed as the display 22A. The user interface 22 is used to set the number of copies and magnification when a copying function is used by the display button of the display 22A or the hardware key 22B, and is used as a dial key of a telephone when a facsimile function is used. Note that, the hardware key 22B may be omitted.

On the other hand, the image forming unit 24 includes sheet storing units 58 in each of which sheets serving as recording media for image formation are stored. In the image forming unit 24, the sheets stored in the sheet storing unit 58 are taken out one by one, and images based on image data are formed on the sheets by, for example, an electrophotographic process. In addition, the sheets on which the images have been formed by the image forming unit 24 are sequentially ejected onto a sheet ejection unit (not illustrated).

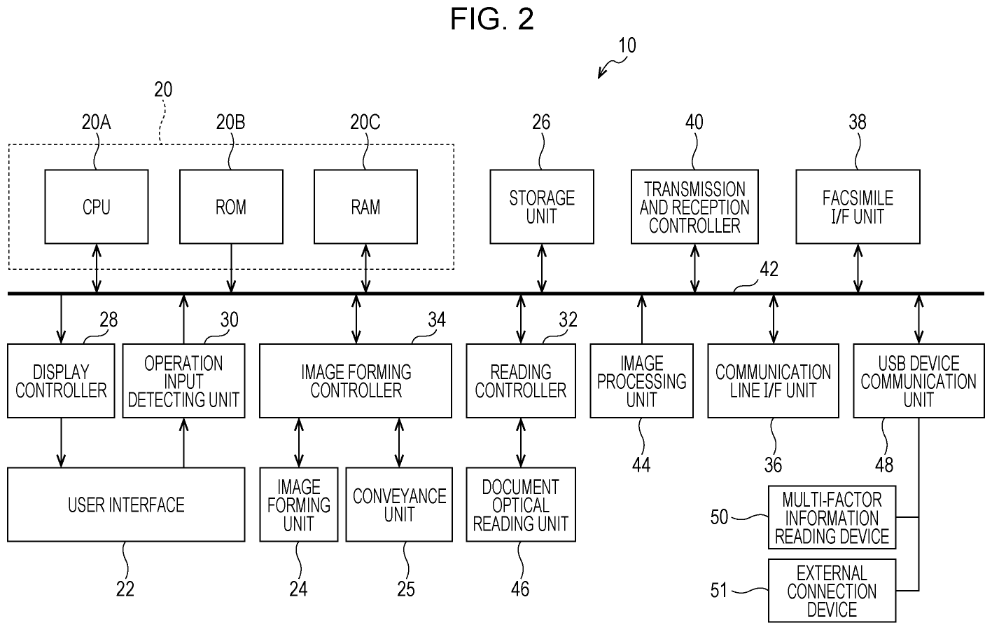

FIG. 2 is a block diagram illustrating a configuration of major parts of an electrical system of the image forming apparatus 10 according to the present exemplary embodiment.

As illustrated in FIG. 2, the image forming apparatus 10 according to the present exemplary embodiment includes a controller 20 including a central processing unit (CPU) 20A, a read only memory (ROM) 20B, and a random access memory (RAM) 20C. The CPU 20A controls an overall operation of the image forming apparatus 10. The RAM 20C is used as a work area or the like when various programs are executed by the CPU 20A. Various control programs, various parameters, and the like are stored in advance in the ROM 20B. Then, in the image forming apparatus 10, the unit of the controller 20 are electrically connected by a system bus 42.

On the other hand, the image forming apparatus 10 according to the present exemplary embodiment includes a storage unit 26 that stores various kinds of data, application programs, and the like. The image forming apparatus 10 further includes a display controller 28 that is connected to the user interface 22 to control display of various operation screens and the like on the display 22A of the user interface 22. The image forming apparatus 10 also includes an operation input detection unit 30 that is connected to the user interface 22 to detect an operation instruction input via the user interface 22. In the image forming apparatus 10, the storage unit 26, the display controller 28, and the operation input detection unit 30 are electrically connected to the system bus 42. Note that, the storage unit 26 may be, as one example, a hard disk drive (HDD) or a nonvolatile storage unit such as a flash memory.

In addition, the image forming apparatus 10 according to the present exemplary embodiment includes a reading controller 32 that controls an optical image reading operation by a document optical reading unit 46 and a document feeding operation by the document conveyance unit, and an image forming controller 34 that controls image forming processing by the image forming unit 24 and the conveyance of the sheets to the image forming unit 24 by a conveyance unit 25. In addition, the image forming apparatus 10 includes a communication line interface (communication line I/F) unit 36 that is connected to a communication line (not illustrated) to transmit and receive communication data to and from another external apparatus such as a server connected to the communication line, and an image processing unit 44 that performs various kinds of image processing. The image forming apparatus 10 further includes a facsimile interface (facsimile I/F) unit 38 that is connected to a telephone line (not illustrated) to transmit and receive facsimile data to and from a facsimile machine connected to the telephone line. The image forming apparatus 10 further includes a transmission and reception controller 40 that controls transmission and reception of facsimile data via the facsimile interface unit 38. In addition, the image forming apparatus 10 includes a multi-factor information reading device 50 that reads multi-factor information such as biological information including fingerprint, face, vein, iris, voiceprint, and signature, and a Universal Serial Bus (USB) device communication unit 48 that communicates with a USB device such as an external connection device 51 including a media reader. In the image forming apparatus 10, the transmission and reception controller 40, the reading controller 32, the image forming controller 34, the communication line interface unit 36, the facsimile interface unit 38, the image processing unit 44, and the USB device communication unit 48 are electrically connected to the system bus 42.

With the above-described configuration, the image forming apparatus 10 according to the present exemplary embodiment accesses, by the CPU 20A, each of the RAM 20C, the ROM 20B, and the storage unit 26. In addition, the image forming apparatus 10 controls, by the CPU 20A, display of information such as operation screens and various messages on the display 22A of the user interface 22 via the display controller 28. In addition, the image forming apparatus 10 controls, by the CPU 20A, actions of the document optical reading unit 46 and the document conveyance unit via the reading controller 32. In addition, the image forming apparatus 10 controls, by the CPU 20A, actions of the image forming unit 24 and the conveyance unit 25 via the image forming controller 34 and controls transmission and reception of communication data via the communication line interface unit 36. In addition, the image forming apparatus 10 controls, by the CPU 20A, transmission and reception of facsimile data by the transmission and reception controller 40 via the facsimile interface unit 38. Further, the image forming apparatus 10 grasps, by the CPU 20A, an operation content in the user interface 22 based on operation information detected by the operation input detection unit 30, and executes various kinds of control based on the operation content. In addition, an authority to use the image forming apparatus 10 and the like are controlled based on the multi-factor information read by the multi-factor information reading device 50 and the information obtained from the external connection device 51.

In addition, in the image forming apparatus 10 according to the present exemplary embodiment, an operation form in which multi-factor authentication is used for authentication of a device administrator is employed. The multi-factor authentication is to perform authentication by combining three different authentication factors of possession information, knowledge information, and biological information. In the present exemplary embodiment, as one example, an example in which authentication is performed by using knowledge information as an example of first authentication information and biological information as an example of second authentication information will be described. As the knowledge information, an ID and a password stored in an integrated circuit (IC) card or the like are read by the external connection device 51. In addition, the biological information is read by the multi-factor information reading device 50. Note that, hereinafter, the biological information may be referred to as multi-factor information.

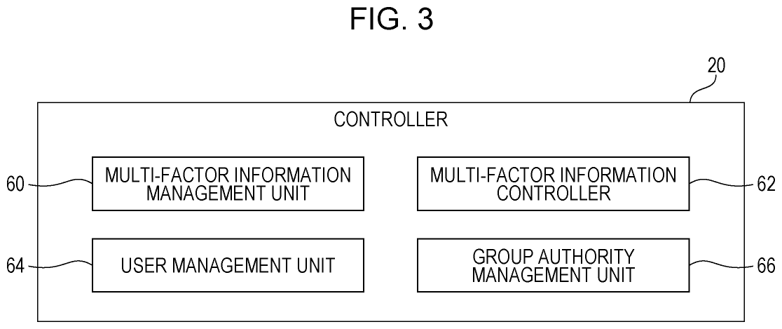

Next, a functional configuration implemented by the CPU 20A of the controller 20 loading a program stored in the ROM 20B into the RAM 20C and executing the program in the image forming apparatus 10 according to the present exemplary embodiment will be described. FIG. 3 is a functional block diagram illustrating an example of a functional configuration of the controller 20 of the image forming apparatus 10 according to the present exemplary embodiment.

The controller 20 has functions of a multi-factor information management unit 60, a multi-factor information controller 62, a user management unit 64, and a group authority management unit 66.

The multi-factor information management unit 60 manages multi-factor information as an example of the second authentication information in which biological information such as fingerprint, face, iris, vein, voiceprint, and signature is associated with a user.

The multi-factor information controller 62 performs control such that the user is authenticated by collating the multi-factor information such as the biological information read by the multi-factor information reading device 50 with the multi-factor information managed by the multi-factor information management unit 60.

The user management unit 64 manages an ID and a password for identifying a user, as an example of the first authentication information. For example, the ID and the password may be read from the IC card or the like by the external connection device 51 such as a media reader, and may be collated with an ID and a password registered in advance. Accordingly, the user may be authenticated and thus managed.

The group authority management unit 66 manages a predetermined authority group permitted to reset or overwrite the multi-factor information. The authority group is set by the device administrator.

Incidentally, as in the present exemplary embodiment, in an operation form in which the multi-factor authentication is used for authentication of the device administrator, it is necessary to update the multi-factor information at the time of person-in-charge handover of the device administrator. Thus, when the device administrator is suddenly absent in a situation where the handover of the person in charge has not been performed, no one can manage the device as the device administrator. Even though the first authentication information which is one of the factors of the multi-factor authentication of the device administrator is shared, since there is no alternative to the second authentication information such as the biological information, a new device administrator is not recognized as the device administrator.

In recent years, from the viewpoint of security enhancement, an operation in which an authority of user management is not given to a maintenance inspector is general. It is necessary for the maintenance inspector to initialize user information in order to restore the original state, and the original state cannot be restored to unless the device itself is initialized. When the device itself is initialized, the stored information is also initialized.

Therefore, in the present exemplary embodiment, in a case where a user of the authority group changes the device administrator or the device administrator is suddenly absent, the user belonging to the authority group gives an instruction about the resetting or overwriting of the multi-factor information of the device administrator, and thus, the multi-factor information controller 62 resets or overwrites the multi-factor information of the device administrator, and performs processing of initializing an ID and a password for the device administrator in a case where the resetting or overwriting of the multi-factor information is performed. Accordingly, login is permitted as the device administrator with the reset or overwritten multi-factor information and the initialized ID and password.

In addition, in a case where the multi-factor information is reset or overwritten, the multi-factor information controller 62 performs processing of reporting the resetting or overwriting of the multi-factor information to the user of the authority group, processing of temporarily prohibiting an authority as the authority group of the user of the authority group, and processing of reporting a fact that the authority is changed to the user of the authority group.

In addition, in a case where the initialized ID and password and the reset or overwritten multi-factor information are received, the multi-factor information controller 62 performs processing of recognizing a new device administrator as the device administrator.

In addition, the multi-factor information controller 62 performs processing of receiving and setting an ID, a password, and multi-factor information for the new device administrator at the time of initial recognition of the device administrator.

In addition, in a case where the setting of the authority group is received from the new device administrator, the multi-factor information controller 62 performs processing for reporting, to the user of the set authority group, a fact that the authority is changed.

Subsequently, specific processing performed by the controller 20 of the image forming apparatus 10 according to the present exemplary embodiment having the above-described configuration will be described.

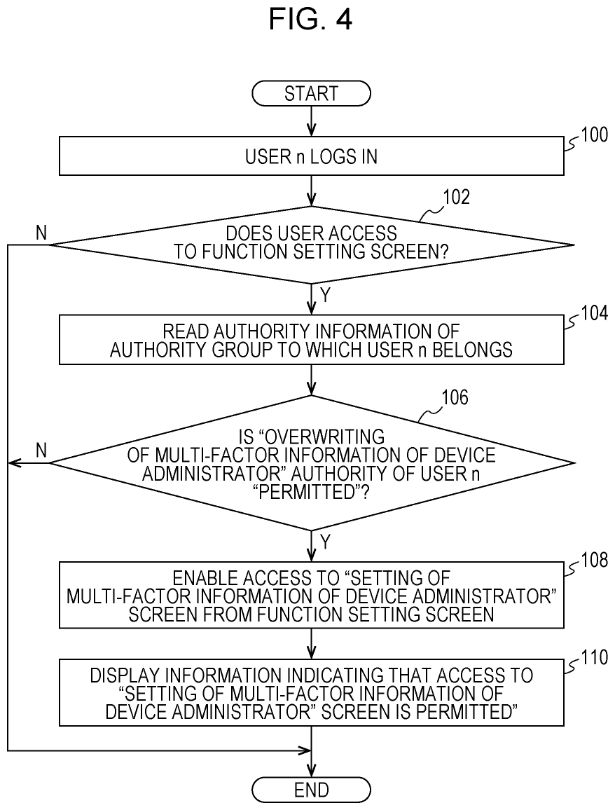

First, processing performed when the user belonging to the authority group resets or overwrites the multi-factor information of the device administrator will be described with reference to FIG. 4. FIG. 4 is a flowchart illustrating an example of a flow of processing performed in the controller 20 of the image forming apparatus 10 according to the present exemplary embodiment when the user belonging to the authority group resets or overwrites the multi-factor information of the device administrator. Note that, the processing of FIG. 4 is started, for example, in a case where the authentication information such as the ID and the password is acquired by reading the IC card or the like by the external connection device 51 and the multi-factor information is read by the multi-factor information reading device 50 and authentication is permitted.

In step 100, a user n logs in, and the CPU 20A proceeds to step 102.

In step 102, the CPU 20A determines whether or not the user n accesses to a function setting screen. The determination is to, for example, determine whether or not the user interface 22 of the image forming apparatus 10 is operated to give an instruction to access to the function setting screen. In a case where this determination is positive, the CPU 20A proceeds to step 104. In a case where another operation is performed, the determination is negative, and the series of processing is ended.

In step 104, the CPU 20A reads authority information of an authority group to which the user n belongs, and proceeds to step 106.

In step 106, the CPU 20A determines whether or not an “overwriting of multi-factor information of device administrator” authority of the user n is “permitted”. The CPU 20A proceeds to step 108 in a case where the determination is positive, and ends the series of processing in a case where the determination is negative.

In step 108, the CPU 20A enables an access to a “setting of multi-factor information of device administrator” screen from the function setting screen, and proceeds to step 110.

In step 110, the CPU 20A displays information indicating that the access to the “setting of multi-factor information of device administrator” screen is enabled, and ends the series of processing. Note that, step 110 may be omitted.

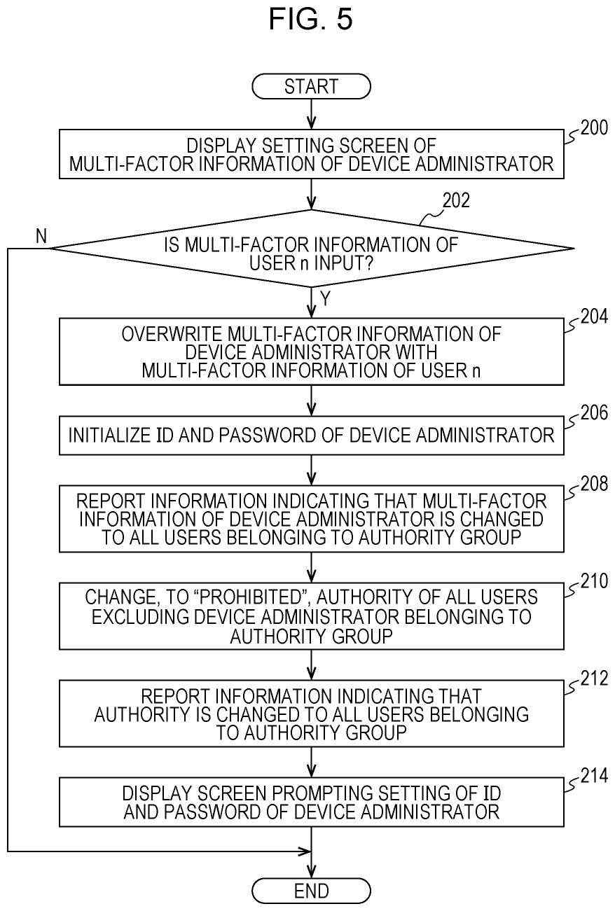

Next, processing performed after the access to the “setting of multi-factor information of device administrator” screen is enabled will be described with reference to FIG. 5. FIG. 5 is a flowchart illustrating an example of a flow of processing performed in the controller 20 of the image forming apparatus 10 according to the present exemplary embodiment after the access to the “setting of multi-factor information of device administrator” screen is enabled. Note that, the processing in FIG. 5 is started in a case where an instruction to display a setting screen of the multi-factor information of the device administrator is given after the processing in FIG. 4.

In step 200, the CPU 20A displays the setting screen of the multi-factor information of the device administrator, and proceeds to step 202.

In step 202, the CPU 20A determines whether or not multi-factor information of the user n is input. The determination is to, for example, determine whether or not the multi-factor information reading device 50 reads the multi-factor information of the user n. The CPU 20A proceeds to step 204 in a case where the determination is positive, and ends the series of processing in a case where the determination is negative.

In step 204, the CPU 20A overwrites the multi-factor information of the device administrator with the multi-factor information of the user n, and proceeds to step 206.

In step 206, the CPU 20A initializes the ID and password of the device administrator, and proceeds to step 208.

In step 208, the CPU 20A reports, to all users belonging to the authority group, information indicating that the multi-factor information of the device administrator is changed, and proceeds to step 210. For example, the report to all the users is performed by transmitting an electronic mail.

In step 210, the CPU 20A temporarily changes the authority of all the users excluding the device administrator belonging to the authority group to “prohibited”, and proceeds to step 212. That is, the authority is temporarily prohibited, and thus, the multi-factor information of the device administrator is prevented from being reset or overwritten by another user of the authority group.

In step 212, the CPU 20A reports, to all the users belonging to the authority group, the information indicating that the authority is changed, and proceeds to step 214.

In step 214, the CPU 20A displays a screen prompting setting of an ID and a password of the device administrator, and ends the series of processing.

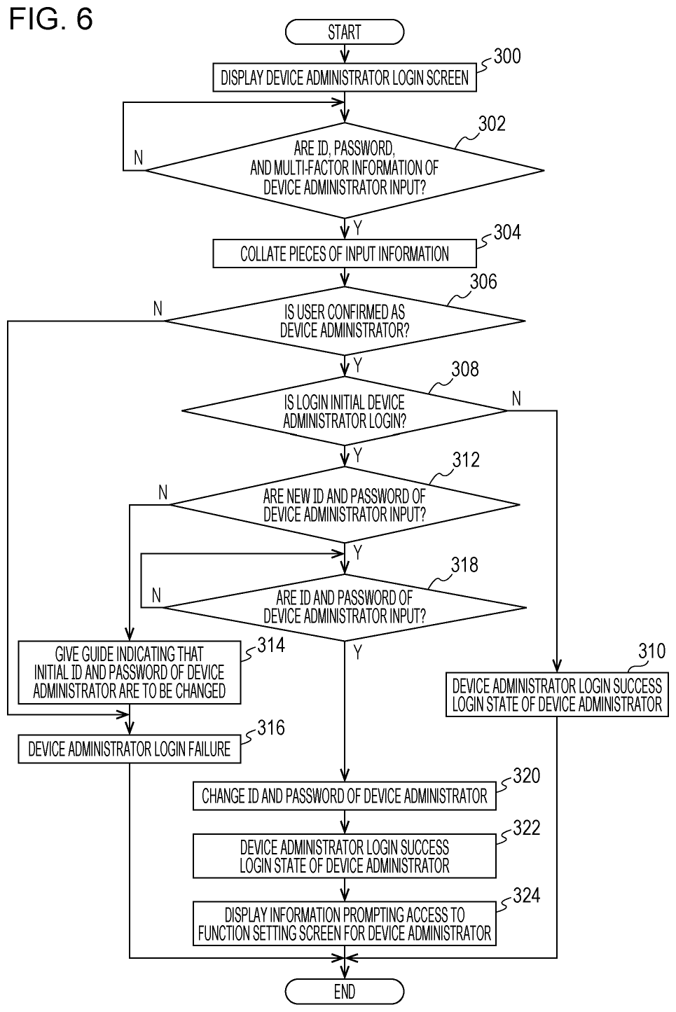

Next, processing of newly setting an ID and a password after the ID and the password of the device administrator are initialized will be described with reference to FIG. 6. FIG. 6 is a flowchart illustrating an example of a flow of processing performed in the controller 20 of the image forming apparatus 10 according to the present exemplary embodiment when an ID and a password are newly set after the ID and the password of the device administrator are initialized. Note that, the processing in FIG. 6 is started, for example, in a case where an instruction to display a device administrator login screen is given after the processing in FIG. 5.

In step 300, the CPU 20A displays the device administrator login screen, and proceeds to step 302.

In step 302, the CPU 20A determines whether or not the ID, password, and multi-factor information of the device administrator are input. The determination is to determine whether or not the initialized ID and password and the multi-factor information are input. The CPU 20A waits until the determination is positive, and then proceeds to step 304.

In step 304, the CPU 20A collates the pieces of input information, and proceeds to step 306. That is, the ID, password, and multi-factor information of the user who resets or overwrite the multi-factor information of the device administrator are collated with the pieces of input information input in step 302.

In step 306, the CPU 20A determines whether or not the user is confirmed as the device administrator. The determination is to determine whether or not a result of collecting the ID, password, and multi-factor information of the user who resets or overwrites the multi-factor information of the device administrator coincide with the pieces of input information input in step 302 is a match. The CPU 20A proceeds to step 308 in a case where the determination is positive, and proceeds to step 316 in a case where the determination is negative.

In step 308, the CPU 20A determines whether or not login is initial device administrator login. The CPU 20A proceeds to step 310 in a case where the determination is negative, and proceeds to step 312 in a case where the determination is positive.

In step 310, the device administrator login succeeds, and the CPU 20A ends the series of processing in a state where the device administrator logs in, and then performs processing of receiving an operation by the device administrator.

On the other hand, in step 312, the CPU 20A determines whether or not an instruction to change the ID and password of the device administrator is given. The CPU 20A proceeds to step 314 in a case where the determination is negative, and proceeds to step 318 in a case where the determination is positive.

In step 314, the CPU 20A gives a guide indicating that the initial ID and password of the device administrator are to be changed, and proceeds to step 316.

In step 316, the CPU 20A ends the series of processing as device administrator login failure.

On the other hand, in step 318, the CPU 20A determines whether or not a new ID and password of the device administrator are input. The CPU 20A waits until the determination is positive, and then proceeds to step 320.

In step 320, the CPU 20A changes the ID and password of the device administrator, and proceeds to step 322.

In step 322, the device administrator login succeeds, and the CPU 20A proceeds to step 324 in a state where the device administrator logs in.

In step 324, the CPU 20A displays information prompting the access to the function setting screen for the device administrator, and ends the series of processing. Note that, the processing in step 324 may be omitted.

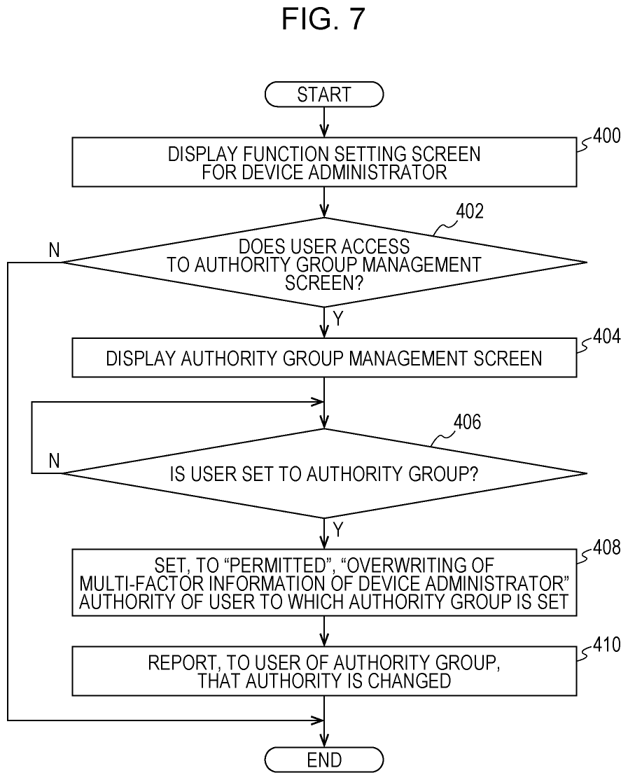

Next, processing performed when the function setting of the device administrator is performed after the new ID and password of the device administrator are set will be described with reference to FIG. 7. FIG. 7 is a flowchart illustrating an example of a flow of processing performed in the controller 20 of the image forming apparatus 10 according to the present exemplary embodiment when the function setting of the device administrator is performed after the new ID and password of the device administrator are set. Note that, the processing in FIG. 7 is started in a case where an instruction to display the function setting screen for the device administrator is given after the processing in FIG. 6.

In step 400, the CPU 20A displays the function setting screen for the device administrator, and proceeds to step 402.

In step 402, the CPU 20A determines whether or not an instruction about an access to an authority group management screen is given. The CPU 20A proceeds to step 404 in a case where the determination is positive, and ends the series of processing in a case where the determination is negative and performs another device administrator setting.

In step 404, the CPU 20A displays the authority group management screen, and proceeds to step 406.

In step 406, the CPU 20A determines whether or not the authority group is set. The determination is to determine whether or not a user to whom the authority group is set is designated. The CPU 20A waits until the determination is positive, and then proceeds to step 408.

In step 408, the CPU 20A sets an “overwriting of multi-factor information of device administrator” authority of the user to which the authority group is set to “permitted”, and proceeds to step 410.

In step 410, the CPU 20A reports, to the user of the authority group, information indicating that the authority is changed, and ends the series of processing. For example, the report to the user of the authority group is performed by transmitting an electronic mail.

Subsequently, the above-described processing performed by the controller 20 of the image forming apparatus 10 according to the present exemplary embodiment will be described with a specific example.

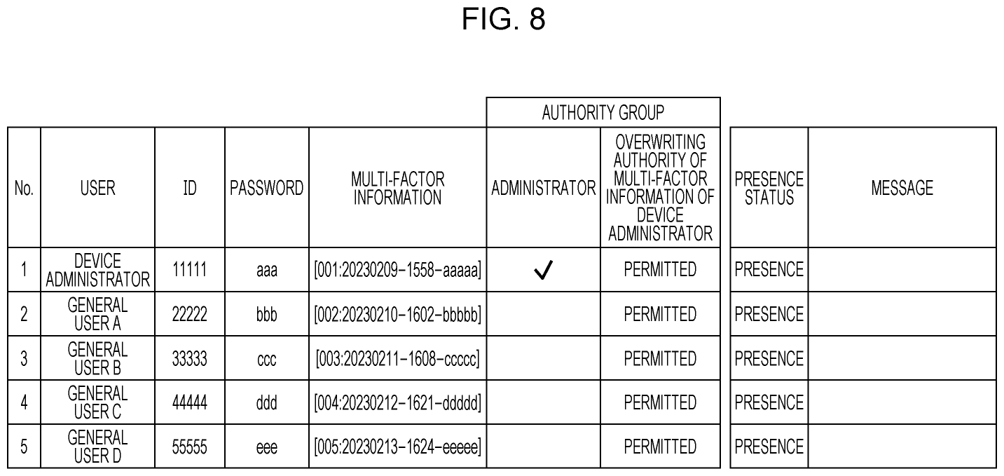

For example, as illustrated in FIG. 8, a case where general users A to D belong to the authority group under the management of the device administrator will be described as an example. FIG. 8 is a diagram illustrating an example of an initial state of IDs, passwords, pieces of multi-factor information, and an authority group of users under the management of the device administrator.

In the examples of the initial state of FIG. 8, for the device administrator, an ID is 11111, a password is aaa, and multi-factor information is [001:20230209-1558-aaaaa]. For a general user A, an ID is 22222, a password is bbb, and multi-factor information is [002:20230210-1602-bbbbb]. For a general user B, an ID is 33333, a password is ccc, and multi-factor information is [003:20230211-1608-ccccc]. For a general user C, an ID is 44444, a password is ddd, and multi-factor information is [004:20230212-1621-ddddd]. For a general user D, an ID is 55555, a password is eee, and multi-factor information is [005:20230213-1624-eeeee]. In FIG. 8, the device administrator and the general users A to D are set to the authority group. Note that, as presence statuses, all of the device administrator and the general users A to D are present. In addition, the users, the IDs, the passwords, the pieces of multi-factor information, and the authority group in FIG. 8 are stored in the controller 20 in advance, and the presence statuses and the messages are described for describing the processing performed by the controller 20.

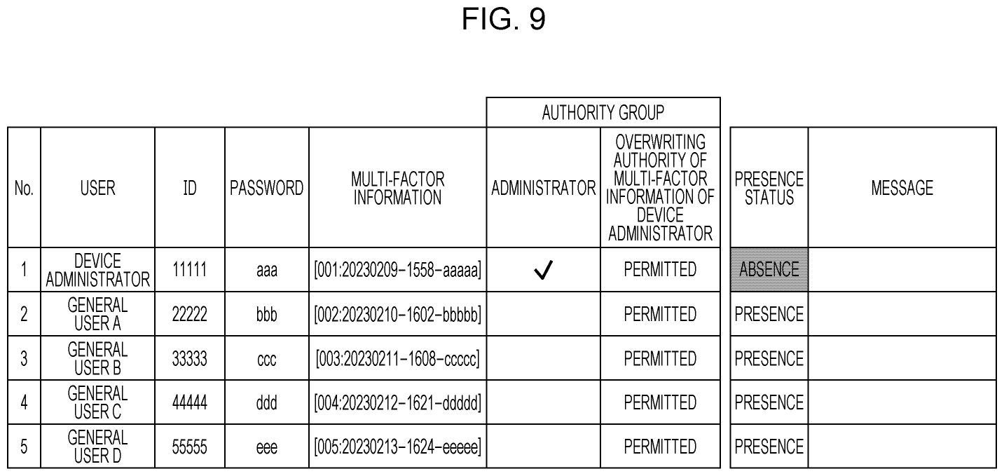

As illustrated in FIG. 9, when the device administrator is in an absent state in a situation in which the handover of the device administrator has not been performed, the management of the device as the device administrator cannot be performed. FIG. 9 is a diagram illustrating the occurrence of the absence state of the device administrator.

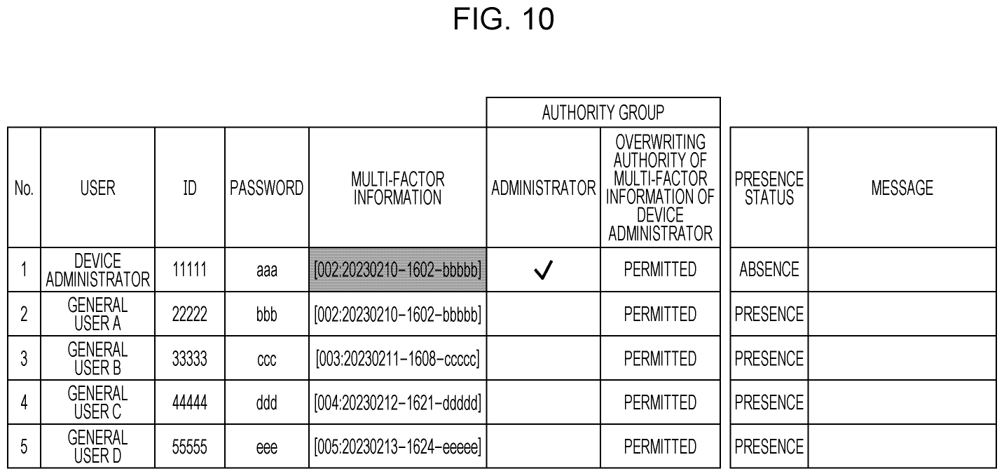

Therefore, the user belonging to the authority group resets or overwrites the multi-factor information of the device administrator. For example, as illustrated in FIG. 10, the general user A belonging to the authority group resets the multi-factor information of the device administrator or overwrites the multi-factor information of the device administrator with the multi-factor information of the general user A. FIG. 10 is a diagram illustrating an example in which the general user A belonging to the authority group overwrites the multi-factor information of the device administrator with the multi-factor information of the general user A.

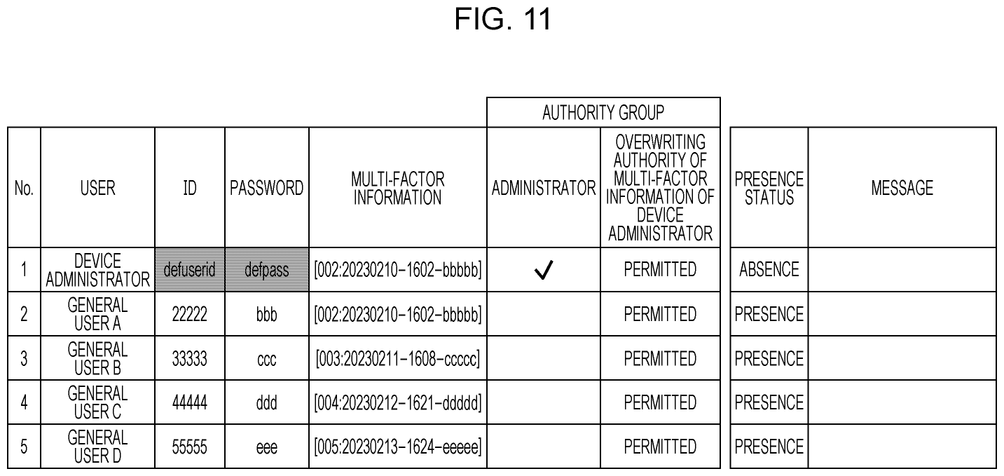

When the general user A executes an authority to reset or overwrite the multi-factor information of the device administrator, the controller 20 resets the ID and password of the device administrator to change the ID and password to initial values as illustrated in FIG. 11. FIG. 11 illustrates an example in which the ID is changed to “defuserid” as the initial value of the ID and the password is changed to “defpass” as the initial value of the password. FIG. 11 is a diagram for describing a behavior of the controller 20 (resetting of the ID and password of the device administrator) when the general user A executes the authority to reset or overwrite the multi-factor information of the device administrator.

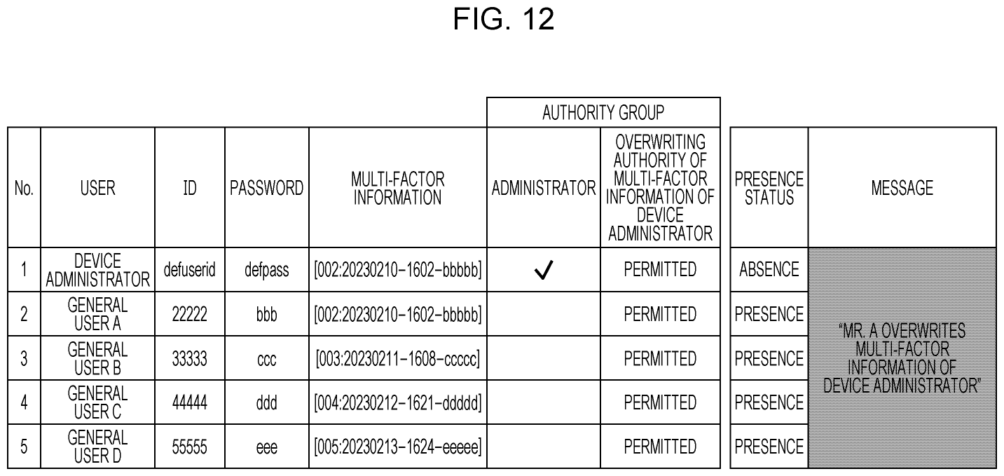

When the ID and the password of the device administrator are reset, as illustrated in FIG. 12, all the users of the authority group are informed of a message such as “Mr. A overwrites multi-factor information of device administrator”. FIG. 12 is a diagram for describing a behavior of the controller 20 (informing the authority group of the resetting or overwriting of the multi-factor information of the device administrator) when the general user A executes the authority to reset or overwrite the multi-factor information of the device administrator.

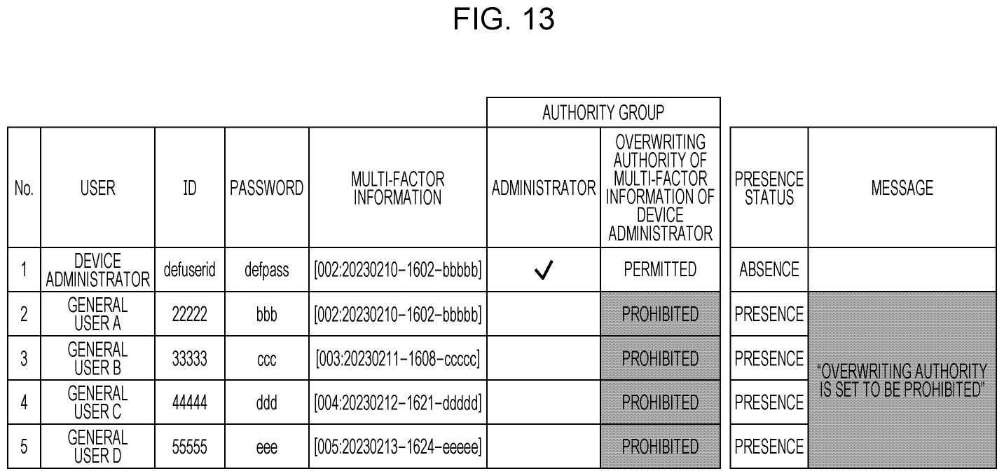

In addition, as illustrated in FIG. 13, all the users excluding the device administrator belonging to the authority group are informed that the authority is changed to “prohibited”, such as “overwriting authority is set to be prohibited”. FIG. 13 is a diagram for describing a behavior of the controller 20 (informing the authority group of the change of the authority) when the general user A resets or overwrites the multi-factor information of the device administrator.

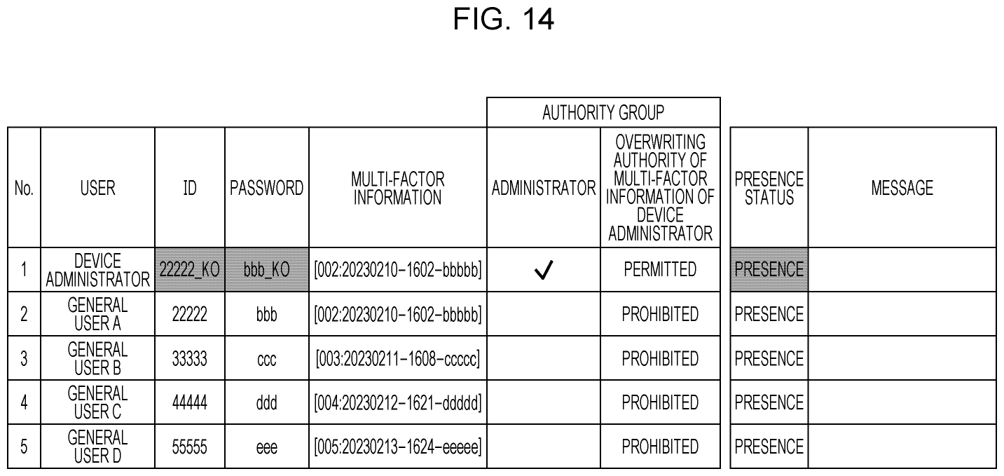

Next, the general user A having the multi-factor information of the device administrator logs in as the device administrator, and changes the initial ID and password of the device administrator at the time of the initial device administrator login. As illustrated in FIG. 14, the ID and the password are changed, and thus, the general user A formally logs in as the device administrator, and the device administrator is in a presence state. Until the ID and password are changed, the device administrator login is not completed, and an operation as the device administrator cannot be performed. FIG. 14 is a diagram illustrating an example in which the ID and password of the device administrator are changed and the general user A logs in as the new device administrator. The example of FIG. 14 illustrates an example in which the ID of the device administrator is changed to 22222_KO and the password is changed to bbb_KO.

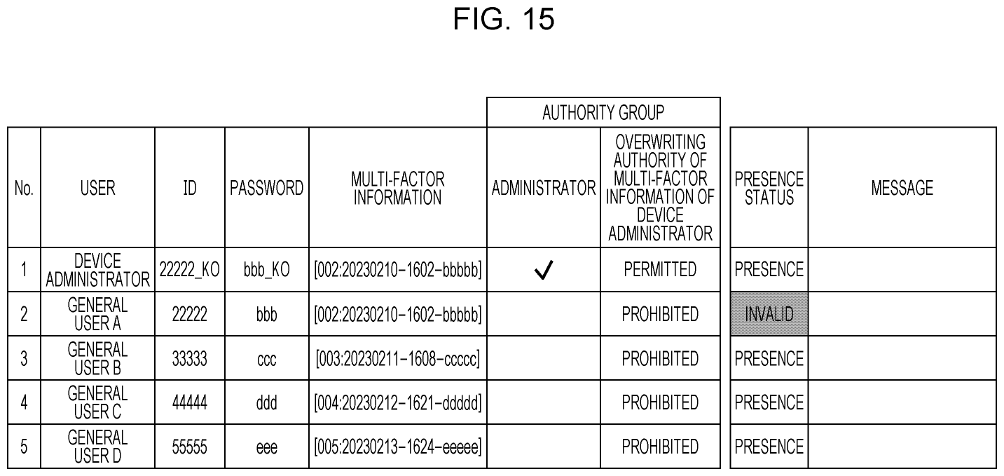

Here, in a case where an account of the general user A is not necessary, the account may be invalidated and locked out, as illustrated in FIG. 15. FIG. 15 is a diagram illustrating an example in which the account of the general user A is locked out.

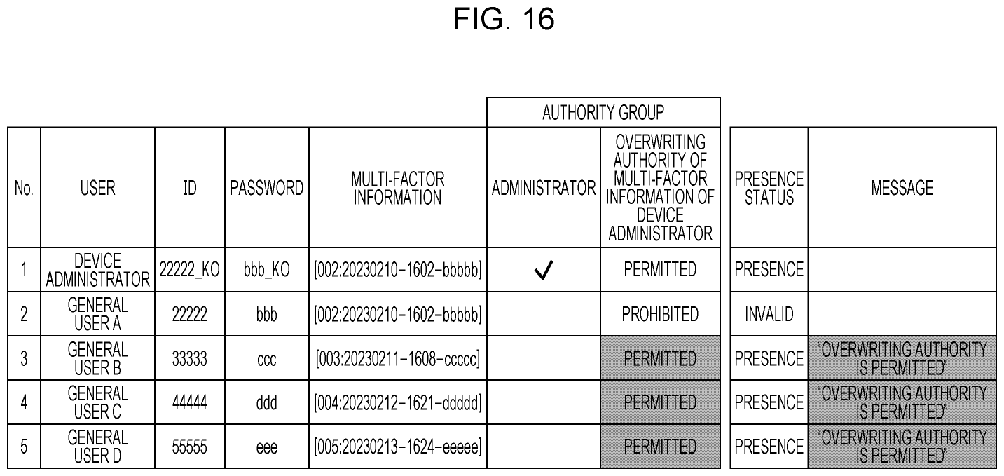

Subsequently, the general user A who is the new device administrator grants the authority of the authority group to a target user of the handover of the new device administrator. For example, as illustrated in FIG. 16, the authority of the authority group is given to the general users B to D.

Then, the target users to whom the authority of the authority group is newly given are informed that the authority is changed. For example, as illustrated in FIG. 16, a message such as “overwriting authority is permitted” is reported to the target users by an electronic mail or the like. FIG. 16 is a diagram for describing a case where the general users B to D are given the authority of the authority group and are informed that the authority is changed.

In this manner, the authority group is set, and thus, even though the device administrator is suddenly absent, the device administrator is changed by the user of the authority group, and the device is managed as the device administrator.

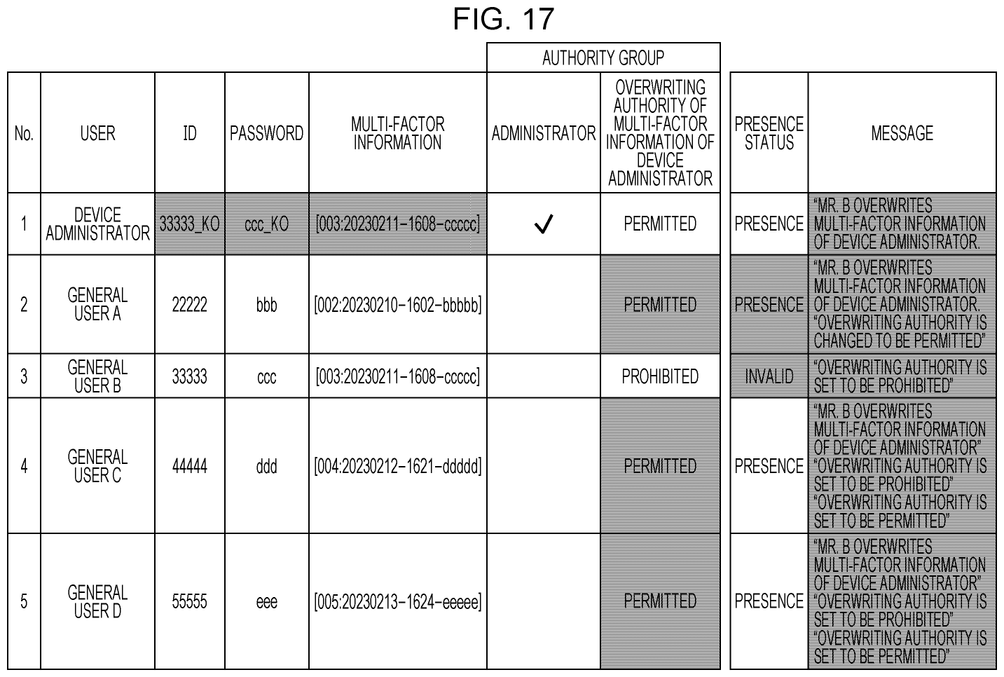

Note that, in the above exemplary embodiment, although the case where the device administrator is absent before the handover has been described, the handover of the device administrator in a state where the device administrator is present is also performed in a similar procedure. For example, a case of handover of the device administrator to the general user B illustrated in FIG. 17 from the user A from the initial state of FIG. 8 will be described. FIG. 17 is a diagram for describing an example of handover of the device administrator to the general user B from the user A in a state where the device administrator is present.

First, the general user B belonging to the authority group resets the multi-factor information of the device administrator or overwrites the multi-factor information with the multi-factor information of the general user B.

When the multi-factor information of the device administrator is reset or overwritten, the ID and password of the device administrator are initialized to the initial values by the controller 20. For example, as the initial values, the ID is initialized to “defuserid”, and the password is initialized to “defupass”.

In addition, all the users belonging to the authority group are informed by the controller 20 that the general user B executes the authority. For example, a message such as “Mr. B overwrites multi-factor information of device administrator” is transmitted to all the users of the authority group.

In addition, the controller 20 changes the authority of all the users excluding the device administrator belonging to the authority group to “prohibited”, and informs all the users except the device administrator belonging to the authority group that the authority is changed. For example, a message such as “overwriting authority is set to be prohibited” is transmitted to all the users of the authority group.

Subsequently, the general user B having the multi-factor information of the device administrator logs in as the device administrator, and changes the initial ID and password of the device administrator at the time of the initial device administrator login. The ID and password are changed, and thus, the general user B formally logs in as the device administrator, and the device administrator is present. Note that, until the ID and password are changed, the device administrator login is not completed, and the operation as the device administrator cannot also be performed.

Here, in a case where an account of the general user B who is the device administrator is not necessary, the account may be locked out and invalidated, as illustrated in FIG. 17.

The general user B grants the authority of the authority group to the general users A, C, and D who are targets of the handover of the new device administrator. Accordingly, the target users are informed by the controller 20 that the authority is changed. For example, a message such as “overwriting authority is set to be permitted” is transmitted to the target users.

As described above, in a case where handover of the device administrator is performed when the device administrator is present, the handover of the device administrator is performed in a similar procedure as in the above-described exemplary embodiment.

Note that, in the above exemplary embodiment, although the image forming apparatus 10 has been described as an example of the information processing system, the information processing system is not limited thereto. For example, another apparatus such as an image processing apparatus may be employed instead of the image forming apparatus 10. Alternatively, a network system including an image forming apparatus and a server may be employed as the information processing system. In this case, part or all of the processing performed by the controller 20 may be performed by the server.

In addition, in the above exemplary embodiment, although the example in which the authentication is performed with a combination of the biological information and the knowledge information has been described as an example of the multi-factor authentication, authentication may be performed with another combination of the possession information, the knowledge information, and the biological information.

In addition, in the above exemplary embodiment, the processor refers to a processor in a broad sense, and includes general-purpose processors (for example, CPUs or the like) and dedicated processors (for example, GPU: Graphics Processing Unit, ASIC: Application Specific Integrated Circuit, FPGA: Field Programmable Gate Array, programmable logic devices, or the like).

In addition, operations of the processor in the above exemplary embodiment may be performed not only by one processor but also by a plurality of processors present at physically distant positions in cooperation with each other. In addition, an order of the operations of the processor is not limited to only the order described in the exemplary embodiment described above but may be appropriately changed.

In addition, although the “system” according to the present exemplary embodiment has been described as being constituted by a plurality of apparatuses as an example, the “system” may be constituted by a single apparatus having some functions of the plurality of apparatuses.

In addition, the processing performed by the controller 20 of the image forming apparatus 10 according to the above exemplary embodiment may be processing performed by software, processing performed by hardware, or processing by combination of both the software and hardware. In addition, the processing performed by the controller 20 of the image forming apparatus 10 may be stored as a program in a storage medium and distributed.

In addition, the present disclosure is not limited to the above description, and it is needless to say that the present disclosure can be variously modified and implemented within a range not departing from the gist thereof.

With respect to the above exemplary embodiment, the following appendices are further disclosed.

(((1)))

An information processing system comprising:
a processor configured to:
   recognize a new device administrator as a device administrator in a case where first authentication information and second authentication information for the device administrator are received;
   reset or overwrite the second authentication information in a case where an instruction to reset or overwrite the second authentication information is given by a user belonging to a predetermined authority group permitted to reset or overwrite the second authentication information for the device administrator; and
   perform processing of initializing the first authentication information for the device administrator in a case where the second authentication information is reset or overwritten.
      (((2)))

The information processing system according to (((1))), wherein the processor is configured to:
report, to a user of the authority group, information indicating that the second authentication information is reset or overwritten, in a case where the second authentication information is reset or overwritten.
   (((3)))

The information processing system according to (((1))) or (((2))), wherein the processor is configured to:
temporarily prohibit an authority, as the authority group, of a user of the authority group in a case where the second authentication information is reset or overwritten.
   (((4)))

The information processing system according to (((3))), wherein the processor is configured to:
report, to the user of the authority group, a fact that the authority is changed to be prohibited.
   (((5)))

The information processing system according to any one of (((1))) to (((4))), wherein the processor is configured to:
recognize the new device administrator as the device administrator, in a case where the initialized first authentication information and the reset or overwritten second authentication information are received.
   (((6)))

The information processing system according to (((5))), wherein the processor is configured to:
receive and set first authentication information and second authentication information for the new device administrator at a time of initial recognition of the device administrator.
   (((7)))

The information processing system according to (((6))), wherein the processor is configured to:
in a case where setting of the authority group is received from the new device administrator, report, to a user of the set authority group, a fact that the authority is changed.
   (((8)))

A program causing a computer to execute a process for information processing, the process comprising:
recognizing a new device administrator as a device administrator, in a case where first authentication information and second authentication information for the device administrator are received;
resetting or overwriting the second authentication information in a case where an instruction to reset or overwrite the second authentication information is given by a user belonging to a predetermined authority group permitted to reset or overwrite the second authentication information for the device administrator; and
performing processing of initializing the first authentication information for the device administrator in a case where the second authentication information is reset or overwritten.

What is claimed is:

1. An information processing system comprising:
a processor configured to:
recognize a new device administrator as a device administrator in a case where first authentication information and second authentication information for the device administrator are received;
reset or overwrite the second authentication information in a case where an instruction to reset or overwrite the second authentication information is given by a user belonging to a predetermined authority group permitted to reset or overwrite the second authentication information for the device administrator; and
perform processing of initializing the first authentication information for the device administrator in a case where the second authentication information is reset or overwritten.

2. The information processing system according to claim 1, wherein the processor is configured to:
report, to a user of the authority group, information indicating that the second authentication information is reset or overwritten, in a case where the second authentication information is reset or overwritten.

3. The information processing system according to claim 1, wherein the processor is configured to:
temporarily prohibit an authority, as the authority group, of a user of the authority group in a case where the second authentication information is reset or overwritten.

4. The information processing system according to claim 3, wherein the processor is configured to:
report, to the user of the authority group, a fact that the authority is changed to be prohibited.

5. The information processing system according to claim 1, wherein the processor is configured to:
recognize the new device administrator as the device administrator, in a case where the initialized first authentication information and the reset or overwritten second authentication information are received.

6. The information processing system according to claim 5, wherein the processor is configured to:
receive and set first authentication information and second authentication information for the new device administrator at a time of initial recognition of the device administrator.

7. The information processing system according to claim 6, wherein the processor is configured to:
in a case where setting of the authority group is received from the new device administrator, report, to a user of the set authority group, a fact that the authority is changed.

8. A non-transitory computer readable medium storing a program causing a computer to execute a process for information processing, the process comprising:
recognizing a new device administrator as a device administrator, in a case where first authentication information and second authentication information for the device administrator are received;
resetting or overwriting the second authentication information in a case where an instruction to reset or overwrite the second authentication information is given by a user belonging to a predetermined authority group permitted to reset or overwrite the second authentication information for the device administrator; and
performing processing of initializing the first authentication information for the device administrator in a case where the second authentication information is reset or overwritten.
